(19) United States
(12) Patent Application Publication
(10) Pub. No.: US 2004/0264117 A1
(43) Pub. Date: Dec. 30, 2004

(54) Electronic device

(76) Inventors: Kuo-Chang Yang, Hsinchu City (TW); Shih-Hwa Lan, Yun Lin Shien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/733,149

(22) Filed: Dec. 11, 2003

(30) Foreign Application Priority Data
Jun. 27, 2003 (TW) 92211736

(51) Int. Cl. G06F 1/16

(52) U.S. Cl. 361/679

(57) ABSTRACT

A fixing assembly for connecting and fixing a hard disk drive to an electronic device. The fixing assembly includes a mounting bracket and a cover. The mounting bracket engages the hard disk drive. The cover flexibly connects the mounting bracket and engages the electronic device.

### BACKGROUND OF THE INVENTION

1. Field of the Invention

The present inventions relates in general to an electronic device and in particular to a fixing assembly in the electronic device for connecting and fixing a hard drive to the electronic device.

2. Description of the Related Art

Typically difficulties are experienced when connecting a conventional removable hard disk drive to a computer due to problems in guiding the connector of the hard drive to engage the socket provided by the main board of the computer. Damage to both connectors frequently occurs due to the improper connection. Further, the hard disk drive and the bracket are directly fixed to the computer, and such an arrangement offers very little shock absorption, hence the vibration generated by computer operation may damage the hard disk drive.

A conventional computer with a removable hard disk drive is shown in FIG. 1. First, the hard disk drive 12 engages the bracket 13. A first connector 122 of the hard disk drive 12 is then connected to a second connector 112 in the computer 11 by the guiding track 114 in the computer 11 along the arrow shown in the FIG. 1. The screws 132 pass through the holes on the hard disk drive 12 and the bracket 13 to engage the threaded holes of the computer 11. Finally, the removable hard disk drive 12 is connected to the computer 11.

### SUMMARY OF THE INVENTION

An object of the present invention is to provide a fixing assembly that solves the above mentioned problem. The fixing assembly can correctly connect the hard disk drive to the computer and provide shock absorption.

The fixing assembly of the present invention includes a mounting bracket and a cover. The mounting bracket engages the hard disk drive. The cover flexibly connects the mounting bracket and engages the electronic device.

The mounting bracket includes a first engaging portion and the cover includes a second engaging portion. The second engaging portion flexibly connects the first engaging portion.

The first engaging portion is a hook and the second engaging portion is a groove. The hook engages the groove to prevent the hard drive from moving along an X axis.

The width of the groove exceeds the width of the hook such that the hard drive can move a predetermined distance along a Y axis.

The mounting bracket further includes a first protrusion and the cover further includes a second protrusion. The second protrusion holds the first protrusion to limit the motion of the hard drive.

The first protrusion is a nose and the second protrusion is an angled lock. The angled lock holds the nose to limit the motion of the hard drive along a Z axis. A gap is formed between the nose and the angled lock such that the hard drive can move a predetermined distance along the Z axis.

The fixing assembly further includes an elastic member disposed between the mounting bracket and the cover to absorb the vibration.

The mounting bracket includes a face and two flanges extending from each end of the face. The cover includes a front plate, two side plates and a bottom plate. The front plate is connected to the bottom plate forming an L shape. The side plates are disposed at opposing ends of the bottom plate to connect the front plate and the bottom plate.

The elastic member is disposed between the face and the front plate.

The elastic member is disposed between each flange and side plate.

The elastic member is disposed between the hard disk drive and the bottom plate.

Further, the present invention discloses an electronic device. The electronic device includes a housing, a main board, a hard disk drive, and a fixing assembly. The main board is disposed in the housing and has a first connector. The hard disk drive has a second connector connected to the first connector. The fixing assembly for connecting and fixing the hard drive to the electronic device includes a mounting bracket and a cover. The mounting bracket engages the hard disk drive. The cover flexibly connects the mounting bracket and engages the electronic device.

The mounting bracket includes a first engaging portion and the cover includes a second engaging portion. The second engaging portion flexibly connects the first engaging portion.

The first engaging portion is a hook and the second engaging portion is a groove. The hook engages the groove to prevent the hard drive from moving along an X axis.

The width of the groove exceeds the width of the hook such that the hard drive can move a predetermined distance along a Y axis.

The mounting bracket further includes a first protrusion and the cover further includes a second protrusion. The second protrusion holds the first protrusion to limit the motion of the hard drive.

The first protrusion is a nose and the second protrusion is an angled lock. The angled lock holds the nose to limit the motion of the hard drive along a Z axis. A gap is formed between the nose and the angled lock such that the hard drive can move a predetermined distance along the Z axis.

The fixing assembly further includes an elastic member disposed between the mounting bracket and the cover to absorb the vibration.

The mounting bracket includes a face and two flanges extending from each end of the face. The cover includes a front plate, two side plates and a bottom plate. The front plate connects to the bottom plate forming an L shape. The side plates are disposed at opposing ends of the bottom plate to connect the front plate and the bottom plate.

The elastic member is disposed between the face and the front plate.

The elastic member is disposed between each flange and side plate.

The elastic member is disposed between the hard disk drive and the bottom plate.

### DESCRIPTION OF THE DRAWINGS

The present invention can be more fully understood by reading the subsequent detailed description in conjunction with the examples and references made to the accompanying drawings, wherein:

FIG. 1 is a perspective diagram of a conventional method of connecting a hard disk drive to a computer;

FIG. 2 is a perspective diagram of a mounting bracket and a cover in accordance with the present invention;

FIG. 3a is perspective diagram of a fixing assembly in accordance with the present invention;

FIG. 3b is a cross section along IIIB-IIIB′ line of FIG. 3a;

FIG. 3c is a cross section along IIIC-IIIC′ line of FIG. 3a;

FIG. 4a is perspective diagram of an electronic device of the present invention before the hard disk drive is connected to the computer;

FIG. 4b is perspective diagram of the computer of the present invention after assembly.

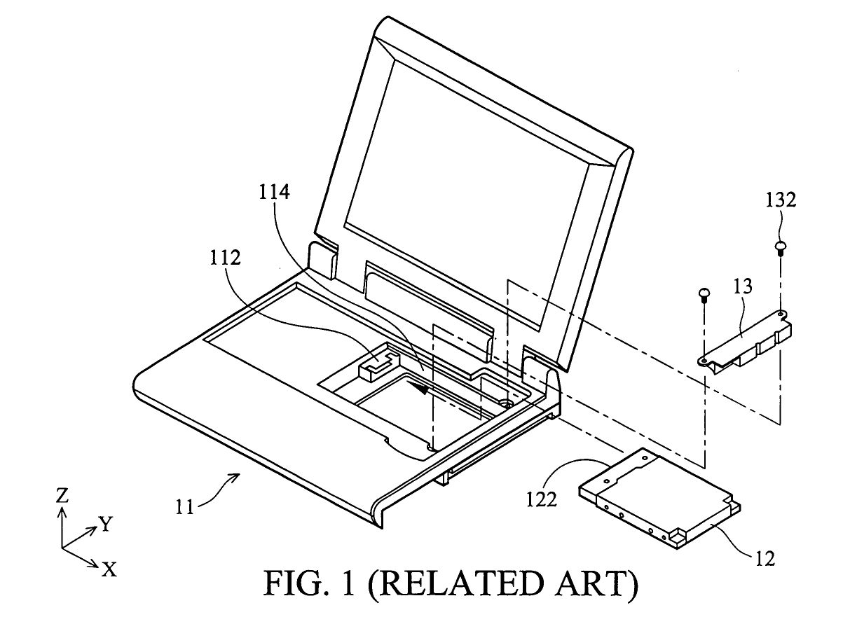

### DETAILED DESCRIPTION OF THE INVENTION

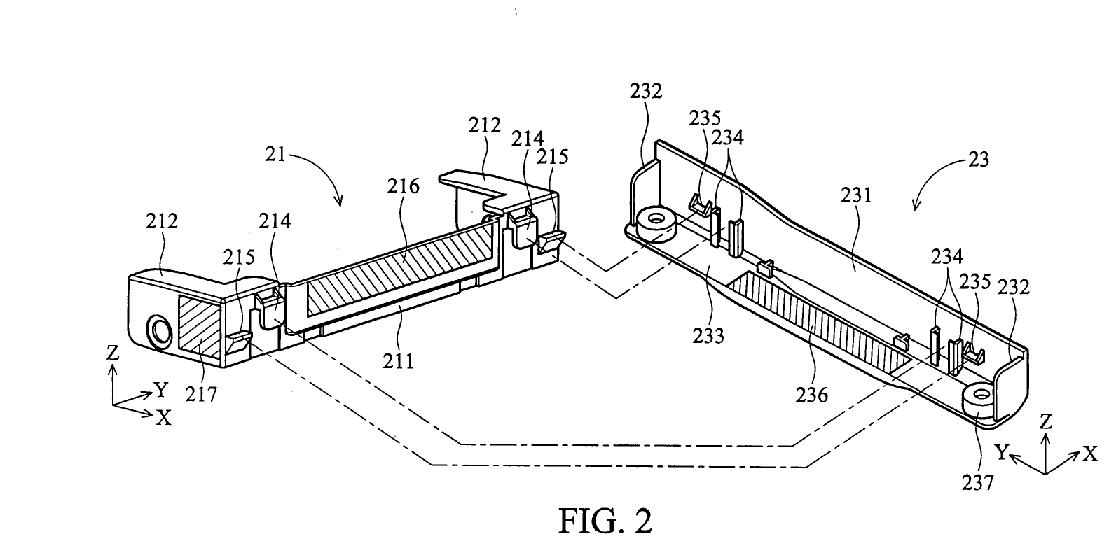

Referring to FIG. 2, a fixing assembly of the present invention for fixing a hard disk drive (not shown in FIG. 2) to an electronic device (not shown in FIG. 2) includes a mounting bracket 21 and a cover 23. The mounting bracket 21 engages the hard disk drive and the cover 23 are flexibly connected to the mounting bracket 21. Meanwhile, the cover 23 engages the electronic device such that the hard disk drive is fixed to the electronic device.

As shown in FIG. 2, the mounting bracket 21 has a face 211 and two flanges 212. The two flanges 212 extend from each end of the face 211. Further, the mounting bracket 21 provides a first engaging portion 214 and a first protrusion 215. In this embodiment, the first engaging portion is a hook and the first protrusion is a nose.

Moreover, the cover 23 has a front plate 231, two side plates 232, and a bottom plate 233. The front plate 231 connects to the bottom plate 233 forming an L shape. The side plates 232 are disposed at opposing ends of the bottom plate 233 to connect the front plate 231 and the bottom plate 233. Further, the cover 23 provides a second engaging portion 234 and a second protrusion 235. In the embodiment, the second engaging portion 234 is a groove and the second protrusion 235 is an angled lock. Additionally, the cover 23 provides an opening 237. A screw may pass through the opening 237 to engage the threaded hole of the electronic device such that the cover 23 is fixed to the electronic device.

The cover 23 is flexibly connected to the mounting bracket 21. When the cover 23 connects to the mounting bracket 21, the site of the hook 214 is corresponding to the site of the groove 234. The hook 214 and the groove 234 have matching profiles, and the site of the nose 215 corresponds to the site of the angled lock 235.

As mentioned above, the hook 214 is flexibly connected to the groove 234. In other words, the hook 214 engages the groove 234 to limit the motion of the hard disk drive along an X axis. A gap is formed between the hook 214 and the groove 234 such that the hard disk drive can move a predetermined distance along the X axis to achieve flexible connection of the mounting bracket 21 to the cover 23.

Further, the width of the groove 234 exceeds the width of the hook 214 such that the hard disk drive can move a predetermined distance along a Y axis to achieve flexible connection of the mounting bracket 21 to the cover 23.

Moreover, the angled lock 235 holds the nose 215 to limit the motion of hard disk drive along a Z axis. A gap is formed between the nose 215 and the angled lock 235 such that hard disk drive can move a predetermined distance along the Z axis to achieve flexible connection of the mounting bracket 21 to the cover 23.

The mounting bracket 21 connects to the cover 23 as mentioned above enabling the hard disk drive to flex in three dimensions when connecting to the electronic device. Thus, the hard disk drive can easily and accurately engage the electronic device avoiding potential damage. Further, after assembly, the hard disk drive maintains its flexible characteristics, improving the shock absorption thereof.

Furthermore, an elastic member is disposed between the mounting bracket 21 and the cover 23 to improve more of the shock absorbing effect.

For example, as shown in FIG. 2, the elastic member 216 is disposed on the face 211 of the mounting bracket 21 and between two flanges 212. When the mounting bracket 21 connects to the cover 23, the elastic member 216 is disposed between the face 211 of the mounting bracket 21 and the front plate 231 of the cover 23. The face 211 and the front plate 231 hold and clamp the elastic member 216. Further, two elastic members 217 are disposed on the outside of the flanges 212 of the mounting bracket 21. When the mounting bracket 21 connects to the cover 23, the elastic member 217 is disposed between the flange 212 of the mounting bracket 21 and the side plate 232 of the cover 23. The flange 212 and the side plate 232 hold and clamp the elastic member 217. Moreover, an elastic member 236 is disposed on the bottom plate 233 of the cover 23. When the mounting bracket 21 connects to the cover 23, the elastic member 236 is disposed between the hard disk drive and the bottom plate 233.

The assembly and operation of the embodiment of the present invention is described in the following.

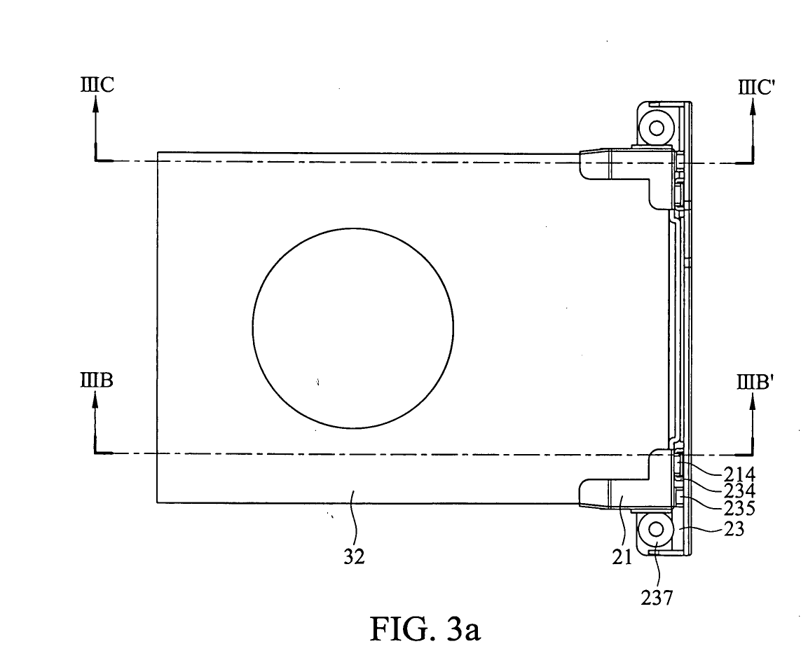

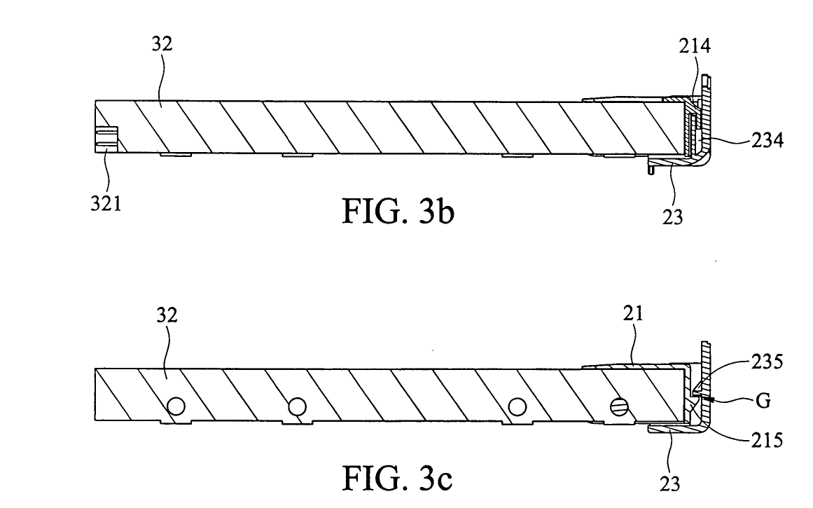

Referring to FIGS. 3a to 3c, a hard disk drive 32 engages a mounting bracket 21, for example using a screw, and then a cover 23 is flexibly connected to the mounting bracket 21. Finally, the cover 23 engages the electronic device and the assembling process is complete. In this embodiment, the mounting bracket 21 is connected to the cover 23 by engaging the hook 214 of the mounting bracket 21 to the groove 234 of the cover 23 (as shown in FIG. 3b). Thus limiting the motion of the mounting bracket 21 along the X axis. Additionally, the angled lock 235 holds the nose 215 (as shown is FIG. 3c) limiting the motion of the mounting bracket 21 along the Z axis. In the embodiment, the cover 23 can be connected to mounting bracket 21 and remain flexible because the hook 214 can move predetermined distance along the X axis with respect to the groove 234. Moreover, the width of the groove 234 exceeds the width of the hook 214 such that the mounting bracket 21 may move a predetermined distance along the Y axis. A gap G is formed between the angled lock 235 and nose 215 such the mounting bracket 21 may move a predetermined distance along the Z axis. Therefore, the mounting bracket 21 maintains three dimensional flexibility with respect to the cover 23 in which the X, Y, and Z axes are perpendicular.

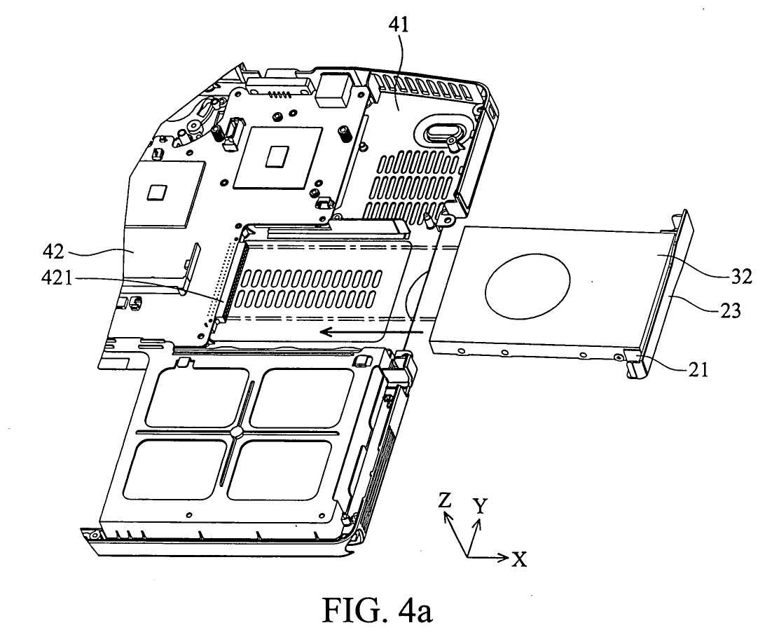

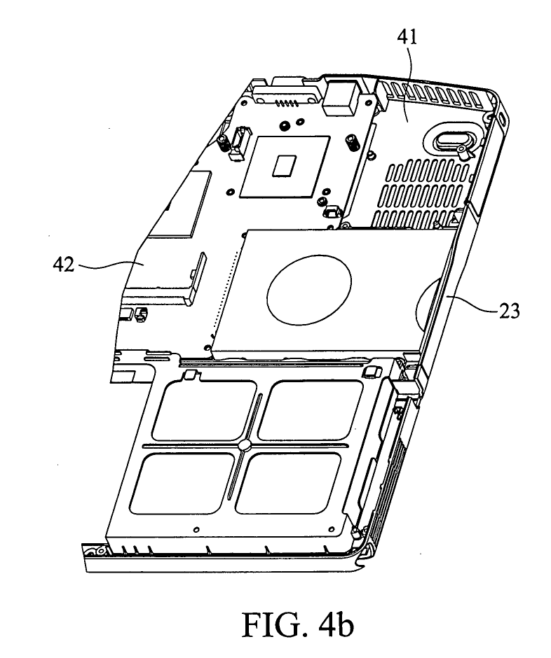

Referring to FIGS. 4a and 4b, an electronic device includes a housing 41, a main board 42, and a hard disk drive 32. The hard disk drive 32 connects to the mounting bracket 21 and the cover 23 via the foregoing method. The second connector 321 (as shown in FIG. 3b) of the hard disk drive 32 is then connected to the first connector 421 of the main board 42 along the arrow as shown in FIG. 4a. Due to the flexible characteristics provided by the present invention, the hard disk drive 32 can move a predetermined distance along the X, Y, and Z axes to correct the connection between the first connector 421 and the second connector 321. Therefore, the hard disk drive 32 may be smoothly connected to the main board 42. Referring to FIG. 4b, after connecting the hard disk drive 32 to the main board 42, the cover 23 engages the housing 41 by a screw to fix the hard disk drive 32 to the electronic device.

Moreover, in the present invention, a elastic member is disposed between the mounting bracket 21 and the cover 23 improving shock absorption. The elastic member, for example, is a rubber spacer.

Finally, while the invention has been described by way of example and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A fixing assembly for connecting and fixing a hard disk drive to an electronic device, comprising:
a mounting bracket for mounting a hard disk drive; and
a cover flexibly connected to the mounting bracket to engage the electronic device.

2. The fixing assembly as claimed in claim 1, wherein the mounting bracket comprises a first engaging portion, and the cover comprises a second engaging portion flexibly connected to the first engaging portion.

3. The fixing assembly as claimed in claim 2, wherein the first engaging portion is a hook and the second engaging portion is a groove, and the hook engages the groove to prevent the hard drive from moving along an X axis.

4. The fixing assembly as claimed in claim 3, wherein the width of the groove exceeds the width of the hook such that the hard disk drive can move a predetermined distance along a Y axis.

5. The fixing assembly as claimed in claim 2, wherein the mounting bracket further comprises a first protrusion and the cover further comprises a second protrusion, and the second protrusion holds the first protrusion to limit the motion of the hard drive.

6. The fixing assembly as claimed in claim 5, wherein the first protrusion is a nose and the second protrusion is an angled lock, the angled lock holds the nose to limit the motion of the hard drive along a Z axis, and a gap is formed between the nose and the angled lock such that the hard drive can move a predetermined distance along the Z axis.

7. The fixing assembly as claimed in claim 1, further comprising an elastic member disposed between the mounting bracket and the cover to absorb vibration.

8. The fixing assembly as claimed in claim 7, wherein the mounting bracket including a face and two flanges extending from each end of the face and the cover including a front plate, two side plates and a bottom plate, the front plate connecting to the bottom plate forming an L shape, and the side plates disposed at opposing ends of the bottom plate to connect the front plate and the bottom plate.

9. The fixing assembly as claimed in claim 8, wherein the elastic member is disposed between the face and the front plate.

10. The fixing assembly as claimed in claim 8, wherein the elastic member is disposed between each flange and side plate.

11. The fixing assembly as claimed in claim 8, wherein the elastic member is disposed between the hard disk drive and the bottom plate.

12. An electronic device, comprising:
a housing;
a main board disposed in the housing and having a first connector;
a hard disk drive having a second connector connected to the first connector; and
a fixing assembly for connecting and fixing the hard drive to the electronic device, comprising:
a mounting bracket engaging the hard disk drive; and
a cover flexibly connected to the mounting bracket and engaging the electronic device.

13. The device as claimed in claim 12, wherein the mounting bracket comprises a first engaging portion and the cover comprises a second engaging portion flexibly connected to the first engaging portion.

14. The device as claimed in claim 13, wherein the first engaging portion is a hook and the second engaging portion is a groove, and the hook engages the groove to prevent the hard drive from moving along an X axis.

15. The device as claimed in claim 14, wherein the width of the groove exceeds the width of the hook such that the hard drive can move a predetermined distance along a Y axis.

16. The device as claimed in claim 13, wherein the mounting bracket further comprises a first protrusion and the cover further comprises a second protrusion, and the second protrusion holds the first protrusion to limit the motion of the hard drive.

17. The device as claimed in claim 16, wherein the first protrusion is a nose and the second protrusion is an angled lock, the angled lock holds the nose to limit the motion of the hard drive along a Z axis, and a gap is formed between the nose and the angled lock such that the hard drive can move a predetermined distance along the Z axis.

18. The device as claimed in claim 12, wherein the fixing assembly further comprises an elastic member disposed between the mounting bracket and the cover to absorb vibration.

19. The device as claimed in claim 18, wherein the mounting bracket includes a face and two flanges extending from each end of the face and the cover including a front plate, two side plates and a bottom plate, the front plate connected to the bottom plate forming an L shape, and the side plates disposed at opposing ends of the bottom plate to connect the front plate and the bottom plate.

20. The device as claimed in claim 19, wherein the elastic member is disposed between the face and the front plate.

21. The device as claimed in claim 19, wherein the elastic member is disposed between each flange and side plate.

22. The device as claimed in claim 19, wherein the elastic member is disposed between the hard disk drive and the bottom plate.
